(19) United States
(12) Patent Application Publication
(10) Pub. No.: US 2018/0361831 A1
(43) Pub. Date: Dec. 20, 2018

(54) VEHICLE SHADE ASSEMBLY

(71) Applicant: Ford Global Technologies, LLC, Dearborn, MI (US)

(72) Inventors: Pietro Buttolo, Dearborn Heights, MI (US); Stuart C. Salter, White Lake, MI (US); James J. Surman, Clinton Township, MI (US); Paul Kenneth Dellock, Northville, MI (US); Annette Lynn Huebner, White Lake, MI (US)

(73) Assignee: Ford Global Technologies, LLC

(21) Appl. No.: 15/622,892

(22) Filed: Jun. 14, 2017

(51) Int. Cl. B60J 1/20; G09F 13/20; G09F 21/04; B60Q 3/57; B60Q 3/82; B60Q 3/60

(52) U.S. Cl. CPC B60J 1/2019; G09F 13/20; B60Q 3/60; B60Q 3/57; B60Q 3/82; G09F 21/04

(57) ABSTRACT

A shade assembly is positioned proximate a window. The shade assembly includes a housing. A shade is configured to deploy from the housing. A user interface includes a switch for selectively activating a feature of a vehicle.

### FIELD OF THE INVENTION

The present disclosure generally relates to switch assemblies and, more particularly, to switch assemblies that may be disposed within a vehicle for controlling one or more features of the vehicle.

### BACKGROUND OF THE INVENTION

A plurality of switches is disposed within vehicles to control a wide range of features. It is desired to dispose these switches in a variety of accessible passenger locations.

### SUMMARY OF THE INVENTION

According to one aspect of the present disclosure, a shade assembly is positioned proximate a window. The shade assembly includes a housing. A shade is configured to deploy from the housing. The shade assembly further includes a user interface having a switch for selectively activating a feature of a vehicle.

According to another aspect of the present disclosure, a shade assembly is disclosed. The shade assembly is positioned proximate a window. The shade assembly includes a housing and a shade. The shade is configured to deploy from the housing. A user interface is disposed on the shade and includes a switch for selectively activating a vehicle feature. The switch is formed with ink that is conductive and stretchable.

According to yet another aspect of the present disclosure, a shade assembly is disclosed. The shade assembly includes a housing and a shade configured to deploy from the housing. A switch is disposed on the shade.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1A is a side view of a luminescent structure rendered as a coating, according to some examples;

FIG. 1B is a top view of a luminescent structure rendered as a discrete particle, according to some examples;

FIG. 1C is a side view of a plurality of luminescent structures rendered as discrete particles and incorporated into a separate structure;

FIG. 2 is a front perspective view of a vehicle equipped with a shade assembly, according to some examples;

FIG. 3 is a perspective view of the shade assembly in a stowed position, according to some examples;

FIG. 4 is a perspective view of the shade assembly in a deployed position, according to some examples;

FIG. 5 is a perspective view of the shade assembly in a deployed position and including a light-producing assembly therein, according to some examples;

FIG. 6 is a perspective view of the shade assembly in a deployed position, and including a light-producing assembly and a luminescent emblem therein, according to some examples;

FIG. 7 is a front exploded view of a user interface of the shade assembly, according to some examples;

FIG. 8 is a cross-sectional view of the shade taken along the line VIII-VIII of FIG. 5, according to some examples;

FIG. 9 is a rear perspective view of the shade assembly having an outboard luminescent structure and an emblem thereon, according to some examples; and

FIG. 10 is a block diagram of a vehicle incorporating the shade assembly therein.

### DETAILED DESCRIPTION OF THE PREFERRED EXAMPLES

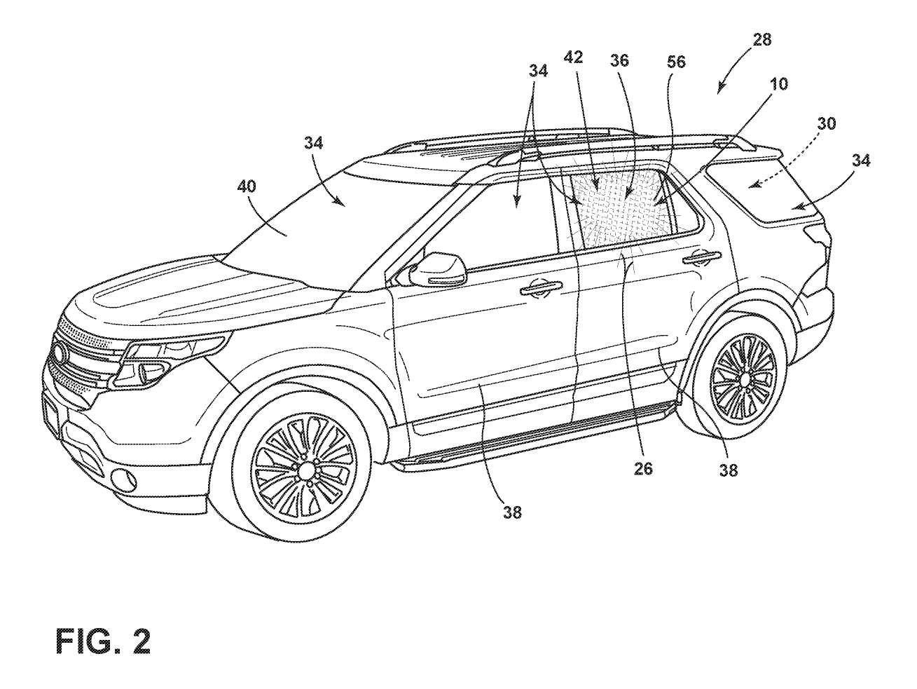

For purposes of description herein, the terms “upper,” “lower,” “right,” “left,” “rear,” “front,” “vertical,” “horizontal,” and derivatives thereof shall relate to the invention as oriented in FIG. 2. However, it is to be understood that the invention may assume various alternative orientations, except where expressly specified to the contrary. It is also to be understood that the specific devices and processes illustrated in the attached drawings, and described in the following specification are simply exemplary examples of the inventive concepts defined in the appended claims. Hence, specific dimensions and other physical characteristics relating to the examples disclosed herein are not to be considered as limiting, unless the claims expressly state otherwise.

As required, detailed examples of the present invention are disclosed herein. However, it is to be understood that the disclosed examples are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For examples, if a composition is described as containing components A, B, and/or C, the composition can contain A alone; B alone; C alone; A and B in combination; A and C in combination; B and C in combination; or A, B, and C in combination.

The following disclosure describes a shade assembly for a vehicle. The shade assembly may include one or more switches thereon. The shade assembly may further employ one or more phosphorescent and/or luminescent structures to luminesce in response to predefined events. The one or more luminescent structures may be configured to convert excitation light received from an associated light source and re-emit the light at a different wavelength generally found in the visible spectrum.

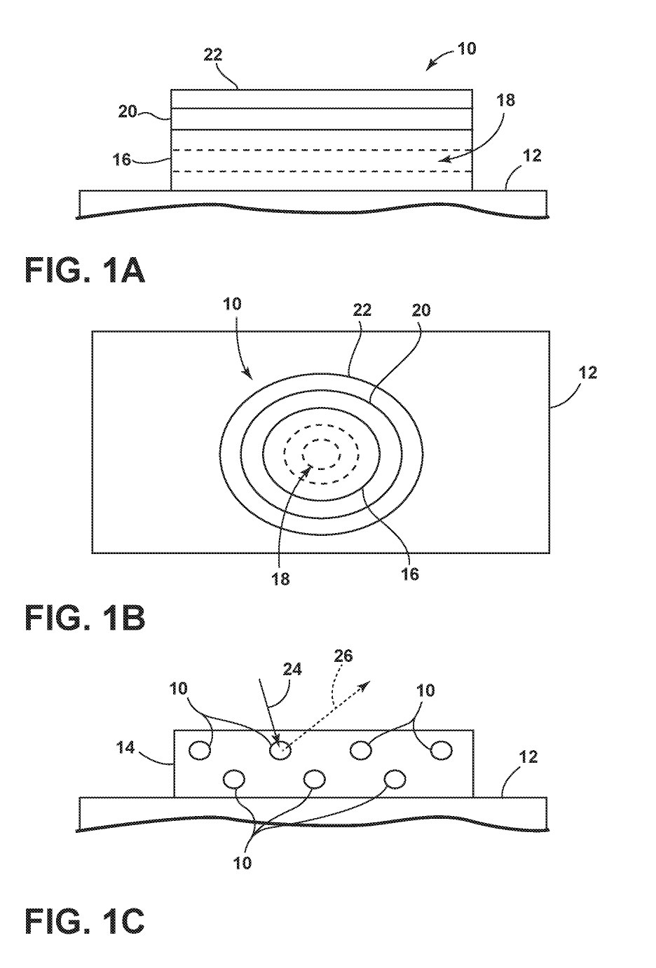

Referring to FIGS. 1A-1C, various exemplary examples of luminescent structures 10 are shown, each capable of being coupled to a substrate 12, which may correspond to a vehicle fixture or vehicle-related piece of equipment. In FIG. 1A, the luminescent structure 10 is generally shown rendered as a coating (e.g., a film) that may be applied to a surface of the substrate 12. In FIG. 1B, the luminescent structure 10 is generally shown as a discrete particle capable of being integrated with a substrate 12. In FIG. 1C, the luminescent structure 10 is generally shown as a plurality of discrete particles that may be incorporated into a support medium 14 (e.g., a film) that may then be applied (as shown) or integrated with the substrate 12.

At the most basic level, a given luminescent structure 10 includes an energy conversion layer 16 that may include one or more sublayers, which are exemplarily shown in broken lines in FIGS. 1A and 1B. Each sublayer of the energy conversion layer 16 may include one or more luminescent materials 18 having energy converting elements with phosphorescent or fluorescent properties. Each luminescent material 18 may become excited upon receiving an excitation light 24 of a specific wavelength, thereby causing the light to undergo a conversion process. Under the principle of down conversion, the excitation light 24 is converted into a longer-wavelength, converted light 26 that is outputted from the luminescent structure 10. Conversely, under the principle of up conversion, the excitation light 24 is converted into a shorter wavelength light that is outputted from the luminescent structure 10. When multiple distinct wavelengths of light are outputted from the luminescent structure 10 at the same time, the wavelengths of light may mix together and be expressed as a multicolor light.

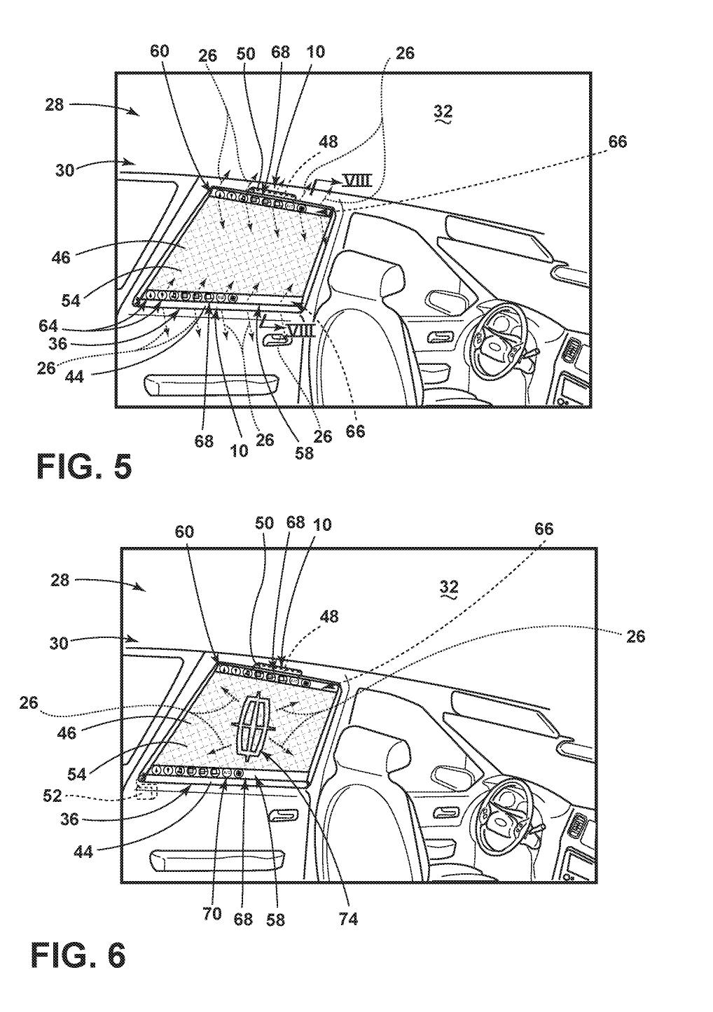

Light emitted by a light-producing assembly 66 (FIG. 5) may be referred to herein as excitation light 24 and is illustrated herein as solid arrows. In contrast, light emitted from the luminescent structure 10 may be referred to herein as converted light 26, or luminescence, and may be illustrated herein as broken arrows.

The energy conversion layer 16 may be prepared by dispersing the luminescent material 18 in a polymer matrix to form a homogenous mixture using a variety of methods. Such methods may include preparing the energy conversion layer 16 from a formulation in a liquid carrier support medium 14 and coating the energy conversion layer 16 to a desired substrate 12. The energy conversion layer 16 may be applied to a substrate 12 by painting, screen-printing, spraying, slot coating, dip coating, roller coating, and bar coating. Alternatively, the energy conversion layer 16 may be prepared by methods that do not use a liquid carrier support medium 14. For examples, the energy conversion layer 16 may be rendered by dispersing the luminescent material 18 into a solid-state solution (homogenous mixture in a dry state) that may be incorporated in a polymer matrix, which may be formed by extrusion, injection molding, compression molding, calendaring, thermoforming, etc. The energy conversion layer 16 may then be integrated into a substrate 12 using any methods known to those skilled in the art. When the energy conversion layer 16 includes sublayers, each sublayer may be sequentially coated to form the energy conversion layer 16. Alternatively, the sublayers can be separately prepared and later laminated or embossed together to form the energy conversion layer 16. Alternatively still, the energy conversion layer 16 may be formed by coextruding the sublayers.

In various examples, the converted light 26 that has been down converted or up converted may be used to excite other luminescent material(s) 18 found in the energy conversion layer 16. The process of using the converted light 26 outputted from one luminescent material 18 to excite another, and so on, is generally known as an energy cascade and may serve as an alternative for achieving various color expressions. With respect to either conversion principle, the difference in wavelength between the excitation light 24 and the converted light 26 is known as the Stokes shift and serves as the principal driving mechanism for an energy conversion process corresponding to a change in wavelength of light. In the various examples discussed herein, each of the luminescent structures 10 may operate under either conversion principle.

Referring back to FIGS. 1A and 1B, the luminescent structure 10 may optionally include at least one stability layer 20 to protect the luminescent material 18 contained within the energy conversion layer 16 from photolytic and thermal degradation. The stability layer 20 may be configured as a separate layer optically coupled and adhered to the energy conversion layer 16. Alternatively, the stability layer 20 may be integrated with the energy conversion layer 16. The luminescent structure 10 may also optionally include a protective layer 22 optically coupled and adhered to the stability layer 20 or other layer (e.g., the conversion layer 16 in the absence of the stability layer 20) to protect the luminescent structure 10 from physical and chemical damage arising from environmental exposure. The stability layer 20 and/or the protective layer 22 may be combined with the energy conversion layer 16 through sequential coating or printing of each layer, sequential lamination or embossing, or any other suitable means.

According to various examples, the luminescent material 18 may include organic or inorganic fluorescent dyes including rylenes, xanthenes, porphyrins, and phthalocyanines. Additionally, or alternatively, the luminescent material 18 may include phosphors from the group of Ce-doped garnets such as YAG:Ce and may be a short-persistence luminescent material 18. For examples, an emission by Ce³⁺ is based on an electronic energy transition from 4D¹ to 4f¹ as a parity allowed transition. As a result of this, a difference in energy between the light absorption and the light emission by Ce³⁺ is small, and the luminescent level of Ce³⁺ has an ultra-short lifespan, or decay time, of 10⁻⁸ to 10⁻⁷ seconds (10 to 100 nanoseconds). The decay time may be defined as the time between the end of excitation from the excitation light 24 and the moment when the light intensity of the converted light 26 emitted from the luminescent structure 10 drops below a minimum visibility of 0.32 mcd/m². A visibility of 0.32 mcd/m² is roughly 100 times the sensitivity of the dark-adapted human eye, which corresponds to a base level of illumination commonly used by persons of ordinary skill in the art.

According to various examples, a Ce³⁺ garnet may be utilized, which has a peak excitation spectrum that may reside in a shorter wavelength range than that of conventional YAG:Ce-type phosphors. Accordingly, Ce³⁺ has short-persistence characteristics such that its decay time may be 100 milliseconds or less. Therefore, in various examples, the rare earth aluminum garnet type Ce phosphor may serve as the luminescent material 18 with ultra-short-persistence characteristics, which can emit the converted light 26 by absorbing purple to blue excitation light 24 emitted from the light-producing assemblies 66. According to various examples, a ZnS:Ag phosphor may be used to create a blue-converted light 26. A ZnS:Cu phosphor may be utilized to create a yellowish-green converted light 26. A Y₂O₂S:Eu phosphor may be used to create red converted light 26. Moreover, the aforementioned phosphorescent materials may be combined to form a wide range of colors, including white light. It will be understood that any short-persistence luminescent material known in the art may be utilized without departing from the teachings provided herein.

Additionally, or alternatively, the luminescent material 18, according to various examples, disposed within the luminescent structure 10 may include a long-persistence luminescent material 18 that emits the converted light 26, once charged by the excitation light 24. The excitation light 24 may be emitted from any excitation source (e.g., any natural light source, such as the sun, and/or any artificial light-producing assemblies 66). The long-persistence luminescent material 18 may be defined as having a long decay time due to its ability to store the excitation light 24 and release the converted light 26 gradually, for a period of several minutes or hours, once the excitation light 24 is no longer present.

The long-persistence luminescent material 18, according to various examples, may be operable to emit light at or above an intensity of 0.32 mcd/m² after a period of 10 minutes. Additionally, the long-persistence luminescent material 18 may be operable to emit light above or at an intensity of 0.32 mcd/m² after a period of 30 minutes and, in various examples, for a period substantially longer than 60 minutes (e.g., the period may extend 24 hours or longer, and in some instances, the period may extend 48 hours). Accordingly, the long-persistence luminescent material 18 may continually illuminate in response to excitation from any light-producing assemblies 66 that emit the excitation light 24, including, but not limited to, natural light sources (e.g., the sun) and/or any artificial light-producing assemblies 66. The periodic absorption of the excitation light 24 from any excitation source may provide for a substantially sustained charge of the long-persistence luminescent material 18 to provide for consistent passive illumination. In various examples, a light sensor may monitor the illumination intensity of the luminescent structure 10 and actuate an excitation source when the illumination intensity falls below 0.32 mcd/m², or any other predefined intensity level.

The long-persistence luminescent material 18 may correspond to alkaline earth aluminates and silicates, for examples, doped di-silicates, or any other compound that is capable of emitting light for a period of time once the excitation light 24 is no longer present. The long-persistence luminescent material 18 may be doped with one or more ions, which may correspond to rare earth elements, for examples, Eu2+, Tb3+, and/or Dy3. According to one non-limiting exemplary examples, the luminescent structure 10 includes a phosphorescent material in the range of about 30% to about 55%, a liquid carrier medium in the range of about 25% to about 55%, a polymeric resin in the range of about 15% to about 35%, a stabilizing additive in the range of about 0.25% to about 20%, and performance-enhancing additives in the range of about 0% to about 5%, each based on the weight of the formulation.

The luminescent structure 10, according to various examples, may be a translucent white color, and in some instances reflective, when unilluminated. Once the luminescent structure 10 receives the excitation light 24 of a particular wavelength, the luminescent structure 10 may emit any color light (e.g., blue or red) therefrom at any desired brightness. According to various examples, a blue emitting phosphorescent material may have the structure Li₂ZnGeO₄ and may be prepared by a high-temperature solid-state reaction method or through any other practicable method and/or process. The afterglow may last for a duration of 2-8 hours and may originate from the excitation light 24 and d-d transitions of Mn2+ ions.

According to an alternate non-limiting exemplary examples, 100 parts of a commercial solvent-borne polyurethane, such as Mace resin 107-268, having 50% solids polyurethane in toluene/isopropanol, 125 parts of a blue-green long-persistence phosphor, such as Performance Indicator PI-BG20, and 12.5 parts of a dye solution containing 0.1% Lumogen Yellow F083 in dioxolane may be blended to yield a low rare earth mineral luminescent structure 10. It will be understood that the compositions provided herein are non-limiting examples. Thus, any phosphor known in the art may be utilized within the luminescent structure 10 without departing from the teachings provided herein. Moreover, it is contemplated that any long-persistence phosphor known in the art may also be utilized without departing from the teachings provided herein.

Referring now to FIGS. 2-6, a vehicle 28 defines a passenger compartment 30 and includes a headliner 32, one or more windows 34, and a shade assembly 36 positioned proximate the window 34. The windows 34 may allow light to enter the passenger compartment 30 of the vehicle 28. The windows 34 may be located about the vehicle 28. In some instances, the windows 34 may be incorporated into doors 38 of the vehicle 28. In the depicted examples, the vehicle 28 is illustrated as a sports utility vehicle, but it will be understood that the vehicle 28 may be a truck, van, sedan, or other type of vehicle 28 without departing from the scope of teachings provided herein. Further, although illustrated in a second-row seating position, the shade assembly 36 may additionally or alternatively be positioned in other rows of seating (e.g., front row seating, third-row seating) of the vehicle 28. Even further, the shade assembly 36 may extend through a trunk or cargo space of the vehicle 28 and/or along a windshield 40 of the vehicle 28 without departing from the teachings provided herein.

Referring to FIGS. 2-4, the shade assembly 36 may be configured to at least partially prevent sunlight or another source of ambient light from entering the passenger compartment 30 through one or more windows 34. The shade assembly 36, which may be located in the passenger compartment 30, may be raised, lowered, and/or otherwise moved between a first state and a second state to block ambient light and raised to allow ambient light to pass through the window 34. While in a deployed position, the amount of ambient light entering the passenger compartment 30 may be reduced. Multiple shades 46 may be disposed throughout the passenger compartment 30. In general, each shade 46 may be associated with one or more windows 34.

In some examples, the luminescent structure 10 may be disposed on an exterior side 42 of the shade assembly 36 and configured to luminesce therefrom. The luminescence may be visible from the outside of the vehicle 28 and reduce visibility into the passenger compartment 30. The reduction in visibility improves privacy within the passenger compartment 30 while the luminescence occurs.

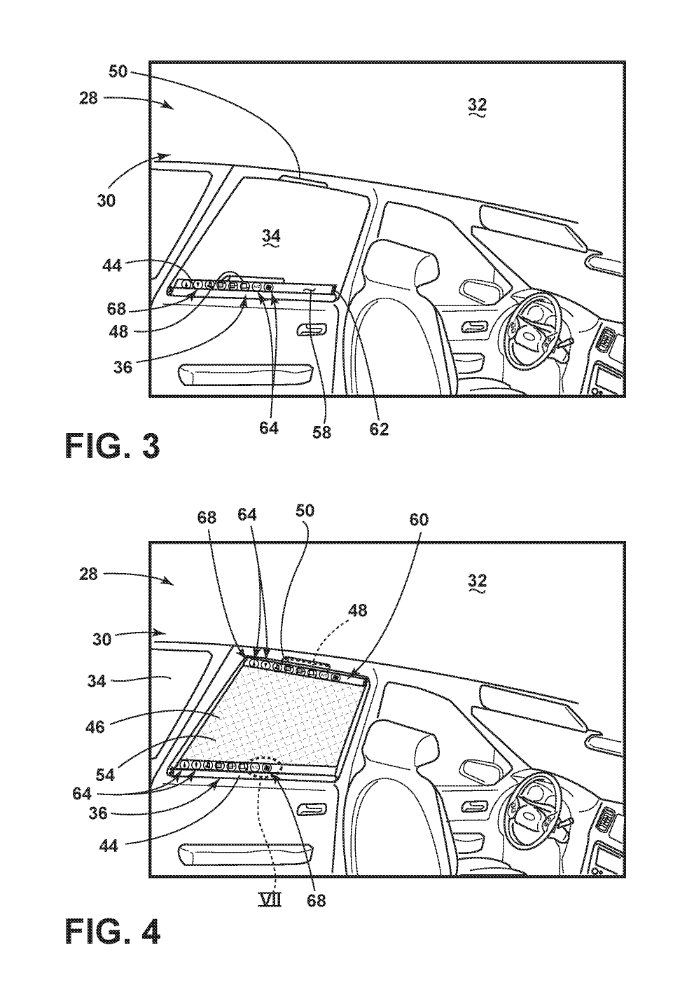

Referring to FIGS. 3-6, the shade assembly 36 includes a housing 44 and a shade 46 configured to extend to a deployed position (FIG. 4) from the housing 44 and retract into a stowed position (FIG. 3) at least partially within the housing 44 when moved by a passenger of the vehicle 28. According to some examples, the shade 46 may include an engaging member 48 that is configured to couple with a retaining member 50 disposed on an opposing side of the window 34 from the housing 44 to maintain the shade 46 in the deployed position. According to some examples, the retaining member 50 may be a latch, a loop or other mechanical retaining device configured to couple with the engaging member 48.

The housing 44 may be attached to any component within the vehicle 28. Moreover, the housing 44 may be integrally formed with any component of the vehicle 24. For example, the housing 44 may be integrally formed with a door panel of the vehicle 28. The housing 44 may include one or more retraction systems for holding, retracting, and deploying the shade 46 from the housing 44. The retraction system may include a roller, which is positioned within the housing 44. The roller may be torsionally biased by a spring or the like to generate tension acting on the shade 46 in the deployed positions. The tension generated by the roller on the shade 46 may keep the shade 46 taut while in the deployed position. Further, when the shade 46 is in the stowed position (e.g., in the housing 44), a holding member 62 may be disposed against the housing 44 to prevent rattling while the vehicle 28 is in motion. The shade 46 may be wound around the roller, and as such, it may be advantageous for each component of the shade 46 to be flexible.

With reference to FIG. 6, the shade assembly 36 may include an electronically driven assembly 52 that moves the shade 46 between the stowed and deployed positions. Each shade 46 may be lowered and/or raised automatically, and the movement of the shade 46 may be in accordance with a motor within the electronically driven assembly 52 and operably connected to the shade 46. Each shade 46 or a group of shades 46 may be individually controlled by a motor. Not all shades 46 may be controlled by the same motor. Thus, at least one shade 46 may be in the stowed position while at least one other shade 46 is in the deployed position, and vice versa.

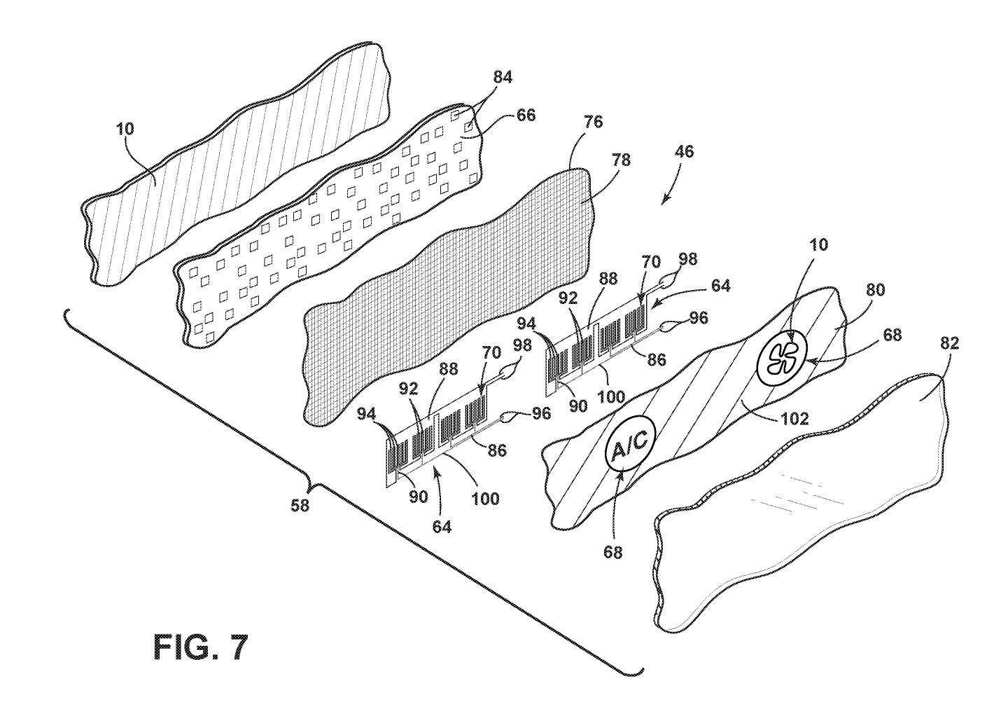

Referring to FIGS. 3-6, the shade 46 may be composed of a fabric material, a plastic material, an elastomeric material, a metallic material, or combinations thereof. In some examples, the shade 46 may be flexible and/or pliable. The shade 46 may have a mesh structure (e.g., fine or coarse) of strands 76 (FIG. 7), fibers, a film structure, or a sheet structure. The shade 46 may have a sufficiently fine structure to block light. In film or sheet examples, the shade 46 may be tinted or otherwise darkened to absorb light. In yet other examples, the shade 46 may be formed from a partially or fully vacuum metalized sheet configured to reflect light. In such examples, the metallization may be grounded. The shade 46 defines both an inboard surface 54 and an outboard surface 56 (FIG. 2).

Referring still to FIGS. 3-6, the shade 46 may include a first user interface 58 disposed proximately to a first end portion of the shade 46 and/or a second user interface 60 disposed proximate a second, opposing end portion of the shade 46. It will be appreciated, however, that the shade 46 may include any number of user interfaces 58, 60 disposed on any location of the shade 46 and/or on the housing 44 without departing from the teachings provided herein. Each user interface includes one or more switches 64 disposed therein. The switches 64 may actuate any vehicle features, such as but not limited to, up and down articulation of the shade 46, up and down articulation of the window 34, vehicle entertainment/acoustic settings, media controls, occupant feature preferences and settings, air conditioning settings, fan speed, defrost, and/or clock adjustment, etc. between a first state and a second state. In some examples, the switches 64 are positioned on an exterior of the shade 46. In such examples, the switches 64 may be capable of being used as an entry keypad, a locking feature, truck or tailgate activation, hood release and/or other controls that may be present on an exterior of the vehicle 28.

The shade 46 may also include a light-producing assembly 66 to provide illumination thereto. The illumination of the shade 46 may be desirable to enhance the visibility of the switches 64, to provide information about usage or function of the shade 46, and/or to provide an aesthetically pleasing light. The light-producing assembly 66 may illuminate indicia 68 on the switches 64. The indicia 68 may provide any desired information, including, but not limited to, the function of the switch 64, the current state of the device that the switch 64 activates, and/or the setting of the device that the switch 64 activates.

The indicia 68 may be defined by one or more luminescent structures 10 that luminesce in response to receiving excitation light 24 of a specific wavelength to illuminate the indicia 68. In some examples, the indicia 68 may be defined by the one or more luminescent structures 10 and configured to provide information to an occupant of the vehicle 28 when the associated light-producing assembly 42 emits excitation light 24 of a specific wavelength causing the one or more luminescent structures 10 to luminesce. In other examples, the indicia 68 may be defined by a translucent and/or an opaque material. The light-producing assembly 66 may additionally and/or alternatively illuminate any remaining portions of the user interfaces 58, 60 and/or any other portion of the shade 46.

In some examples, the first user interface 58 may be capable of accepting inputs (e.g., capable of being activated) when the shade 46 is in the stowed position while the second user interface 60 is concealed within the housing 44. When the shade 46 is disposed in the deployed position thereby providing access to the first and second user interfaces 58, 60, the first and/or second user interfaces 58, 60 may be capable of accepting inputs. Moreover, the switches 64 on the first user interface 58 may control a first set of vehicle features when the shade 46 is in stowed position and a second set of features when the shade 46 is in the deployed position. Additionally and/or alternatively, each user interface 58, 60 may have switches 64 that dynamically change based on a vehicle condition. For examples, one or more switches 64 may control a vehicle audio system in a first state and a display within the vehicle 28 when the display is activated.

As will be described in greater detail below, in some examples, the switch 64 may be configured as a proximity switch 70. The proximity switch 70 provides a sense activation field 72 for sensing contact or close proximity (e.g., within one millimeter) of an object, such as the hand (e.g., palm or finger(s)) of an operator in relation to the proximity switch 70. The proximity switch 70 may also detect a swiping motion by the hand of the operator such as a swipe of the thumb or another finger. It will be appreciated by those skilled in the art that additional or alternative types of proximity switches 70 can be used, such as, but not limited to, capacitive sensors, inductive sensors, optical sensors, temperature sensors, resistive sensors, the like, or a combination thereof. Exemplary proximity switches 70 are described in the Apr. 9, 2009, ATMEL® Touch Sensors Design Guide, 10620 D-AT42-04/09, the entire reference is incorporated herein by reference. It will be appreciated that the switch 64 may alternatively be a mechanical switch of any type known in the art, such as a push button. In push button examples, a membrane may be provided as a seal over the switch 64. Depression of the membrane causes depression of a plunger on the switch 64. Internal switch contacts then change positions to provide an output signal.

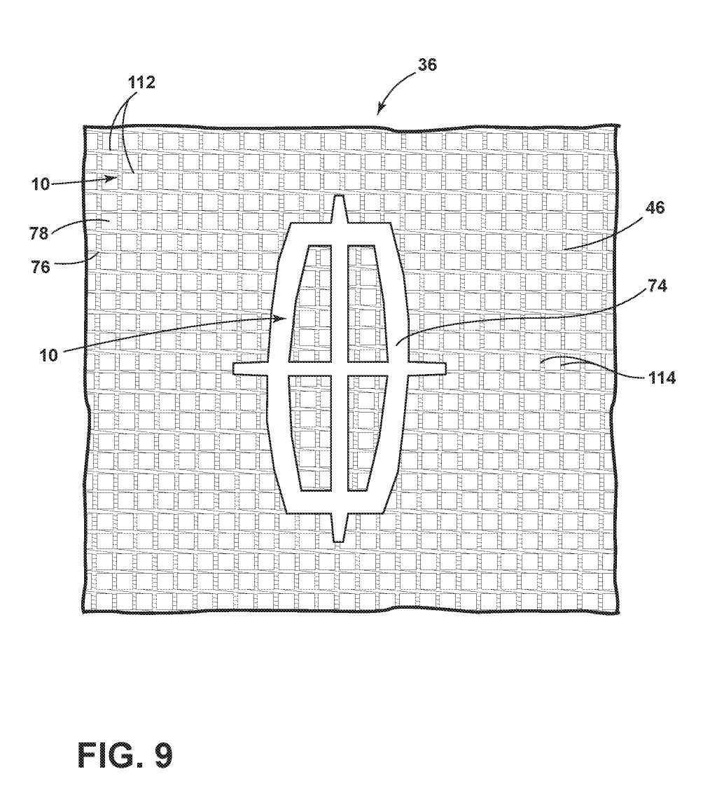

Referring to FIG. 6, an emblem 74 may be disposed on the shade 46. The emblem 74 may be defined by a luminescent structure 10 and configured to illuminate in response to receiving excitation light 24. The excitation light 24 may be emitted from the light-producing assembly 66. Additionally and/or alternative the luminescent structure 10 may accept natural excitation light 24 that is transmitted through the window 34. In some examples, the shade 46 includes a plurality of strands 76 that define voids 78 (FIG. 9) therebetween through which the natural excitation light 24 may pass.

Referring to FIG. 7, the user interface 58, 60 may include a luminescent structure 10 on an outboard side thereof. The light-producing assembly 66 may also be disposed on an outboard side of the shade 46. The switches 64 may be disposed on an inboard side of the shade 46. However, in some examples, the switches 64 may additionally and/or alternatively be disposed on an outboard side of the shade 46. Indicia 68, which may be defined by the luminescent structure 10, is disposed in an indicia layer 80 that is positioned on the switches 64. A protective layer 82 may be disposed on the indicia layer 80.

The outboard luminescent structure 10 may include one or more luminescent materials therein. For examples, the outboard luminescent structure 10 may include a rylene dye material and/or a phosphor. Additionally or alternatively, in some examples, the outboard luminescent structure 10 may include a long persistence luminescent material such that the luminescent structure 10 continues to emit light for long periods of time once excitation light 24 is no longer present. As discussed above, the long persistence luminescent material 18, according to some examples, may be operable to emit light at or above an intensity of 0.32 mcd/m² after a period of 10 minutes. Additionally, the long persistence luminescent material 18 may be operable to emit light above or at an intensity of 0.32 mcd/m² after a period of 30 minutes and, in some examples, for a period substantially longer than 60 minutes (e.g., the period may extend 24 hours or longer, and in some instances, the period may extend 48 hours). Accordingly, the long persistence luminescent material 18 may continually illuminate in response to excitation from any light source(s) and/or light-producing assembly 66 that emits the excitation light 24, including, but not limited to, natural light sources (e.g., the sun) and/or any artificial light-producing assembly 66. The periodic absorption of the excitation light 24 from any excitation source may provide for a substantially sustained charge of the long persistence luminescent material 18 to provide for consistent passive illumination.

As a result of the illumination, which may be provided by the luminescence of the outboard luminescent structure 10, the visibility through the window 34 becomes obscured to onlookers located outside the vehicle 28. The outboard luminescent structure 10 may be configured to illuminate when a vehicle occupant(s) desires privacy. Additionally or alternatively, other windows 34 of the vehicle 28, such as the windshield 40, rear window, and/or roof window (e.g., moonroof/sunroof) may be similarly configured to illuminate in other examples.

The light-producing assembly may include any number of light sources 84 and may be flexible and/or pliable. The flexibility of the light-producing assembly 66 may allow the light-producing assembly 66 to be disposed within the housing 44 in a linear and/or non-linear orientation while maintaining its functionality once the shade 46 is returned to the deployed position. In some examples, the light-producing assembly 66 may be configured to emit visible and/or non-visible light, such as blue light, ultraviolet (UV) light, infrared light, and/or violet light and may include any form of light source. For examples, fluorescent lighting, light-emitting diodes (LEDs), organic LEDs (OLEDs), polymer LEDs (PLEDs), laser diodes, quantum dot LEDs (QD-LEDs), solid-state lighting, a hybrid of these or any other similar device, and/or any other form of lighting may be utilized within the shade assembly 36. Further, various types of LEDs are suitable for use within the light-producing assembly 66 including, but not limited to, top-emitting LEDs, side-emitting LEDs, and others.

The switches 64 may incorporate proximity sensors 70 that may be configured as capacitive sensors 86. Each of the capacitive sensors 86 includes a first electrode 88 and a second electrode 90. Each of the first and second electrodes 88 and 90 includes a plurality of conductive electrode fingers 92 and 94, respectively. As such, the first electrode 88 has a first plurality of electrode fingers 92 and the second electrode 90 has a second plurality of electrode fingers 94. Each of the first and second electrode plurality of fingers 92 and 94 is generally positioned to be interdigitated or interlaced with the other of the first and second plurality of electrode fingers 92 and 94 to at least some degree to generate a capacitive activation field 72 for sensing the presence of an object. The first electrode 88 may be configured as a receive electrode and receives a sense signal, and the second electrode 90 may be configured as a drive electrode to receive a drive signal.

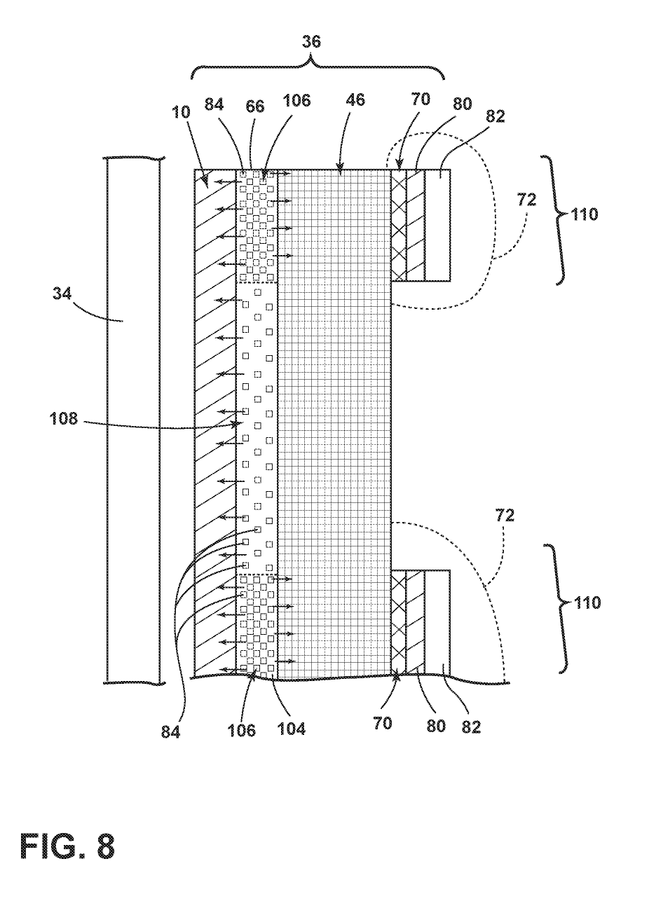

The capacitive sensors 86 each provide a capacitive sense activation field 72 (FIG. 8) to sense contact or close proximity (e.g., within one mm) of an object (e.g., an occupant's hand and/or finger) in relation to the corresponding capacitive sensor 86. The capacitive sense activation field 72 of each capacitive sensor 86 detects the object which has electrical conductivity and dielectric properties that cause a change or disturbance in the capacitive sense activation field 72 as should be evident to those skilled in the art. Each of the capacitive sensors 86 provides a sensed signal for a corresponding proximity sensor 70 indicative of a switch activation.

According to some examples, the drive electrode 90 receives square wave drive signal pulses applied at voltage V_{I}. The receive electrode 88 has an output for generating an output voltage V_{O}. It should be appreciated that the electrodes 88 and 90 and electrode fingers 92 and 94 may be arranged in various configurations for generating the capacitive fields as the sense activation fields 72, according to various examples. The drive electrodes 90 receive drive input signals V_{I} on drive traces 96. The capacitive sensors 86 have a common output trace 98 for outputting the corresponding voltage V_{O}. It will be appreciated that the drive and receive electrodes 88, 90 may be otherwise configured so that other types of a single electrode or other multiples of electrode arrangements may be used. The capacitive sensor 86 may advantageously be formed with conductive ink 100 or may alternatively be formed with flex circuitry.

In the examples shown and described herein, the drive electrode 90 of each capacitive sensor 86 is supplied with input voltage V_{I} as square wave signal pulses having a charge pulse cycle sufficient to charge the receive electrode 88 to a desired voltage. The receive electrode 88 thereby serves as a measurement electrode. The adjacent sense activation fields 72 generated by adjacent capacitive sensors 86 may overlap slightly, or overlap may not exist. When a switch activation/deactivation is desired, an object enters a capacitive sense activation field 72. The corresponding capacitive sensor 86 detects a disturbance caused by the object to the activation field 72 and determines whether the disturbance is sufficient to generate an input with the corresponding capacitive sensor 86. The disturbance of the activation field 72 is detected by processing the charge pulse signal associated with the corresponding signal channel for that capacitive sensor 86. Each capacitive sensor 86 has its own dedicated signal channel generating a distinct charge pulse signal, which may be processed individually.

The capacitive sensors 86 and/or any other electrical lead within the shade assembly 36 may be formed by printed conductive ink 100 or by assembling preformed conductive circuitry onto a substrate. In some examples, the ink 100 is conductive and stretchable and can be applied directly to or transferred onto the shade 46. The stretchable, conductive ink 100 may be moved through numerous stowed/deployed cycles with the shade 46 without breaking and while maintaining a stable set of electrical properties such as conductance over time and use. Additionally, the conductive ink 100 may be disposed in a stretchable conductive ink pattern and/or a stretchable insulator may be disposed over/surrounding the conductive ink 100. The stretchable, conductive ink 100 may include a percentage of conductive material (e.g., around/approximately 20%, 25%, 30%, 35%, 40%, 45%, 50%, 55%, 60%, 65%, 70%), and a binder (e.g., acrylic binder that is formaldehyde-free), a thickener (e.g., polyurethane thickener) and a humectant and/or solvent (e.g., propylene glycol). The stretchable conductive ink 100 may be configured to generally meet a minimum conductance as well as a minimum stretching property.

In general, the stretchable conductive ink 100 may have a stretchability ranging from 5% to 200%, e.g., it may be stretched more than two times (200%) of its at-rest length without breaking. In some examples, the stretchable conductive ink 100 can be stretched to more than three times (300%), more than four times (400%), or more than five times (500%) of its neutral, at rest length. The stretchable conductive ink 100 is conductive and may have a low resistivity. Structurally, the stretchable conductive ink 100 described herein may be made from a specified combination of an insulative adhesive and a conductive material. In general, a stretchable conductive ink 100 may include a first (or base) layer of insulative and elastic adhesive and a layer of the conductive material, where the conductive material includes between about 40% and about 60% of conductive particles (e.g., carbon black, graphene, graphite, silver metal powder, copper metal powder, or iron metal powder, etc.).

The indicia layer 80 includes indicia 68 that notify the vehicle feature that is controlled by the switch 64. The indicia layer 80 also includes a background portion 102 that provides background illumination for the one or more user interfaces 58, 60, task lighting, and/or ambient lighting for the vehicle 28. The background portion 102 may surround the indicia 68. As discussed above, the indicia 68, in some examples, may be defined by a luminescent structure 10. In examples in which the background portion 102 and indicia 68 include luminescent structures 10, the luminescent structures 10 may luminesce in various colors and/or in response to varying wavelengths of excitation light 24.

The protective layer 82, or laminate, may be positioned over the indicia layer 80 and may protect the indicia layer 80 from damage and wear during use. The protective layer 82 may also protect the shade 46 and/or user interface 58, 60 from the environmental contaminants, such as dirt and water, which may come in contact with the interior of the vehicle 28. The protective layer 82 may be formed of any practicable transparent and/or translucent material known in the art and may absorb UV light, thereby preventing sunlight from exciting the luminescent structure 10 in some examples. In alternative examples, the protective layer 82 may be configured to absorb light of any other wavelength, or multiple wavelengths. Alternatively, the protective layer 82 may allow UV light, or any other desired wavelength of light, to pass therethrough.

Referring to FIG. 8, the shade assembly 36 includes a plurality of layers, as provided herein. As illustrated in FIG. 8, the light-producing assembly 66 may include light sources 84 that may be printed and have largely coplanar electrodes. An example of light sources 84 that may be used with the technology described herein is described in U.S. Pat. No. 8,415,879 to Lowenthal et al., which is incorporated by reference herein.

In various examples, individual light sources 84 (e.g., LEDs) may be disposed (e.g., printed, laminated, captured) on a substrate 104 (e.g., a thin film having a thickness of less than 0.25 millimeters, a thin film having a thickness of 0.2 millimeters, a thin film having a thickness of 0.1 to 0.15 millimeters, a thin film having a thickness of 0.07 to 0.1 millimeters, a thin film having a thickness of 0.006 to 0.012 millimeters, a flexible thin film). In FIGS. 7 and 8, discrete units appear to be illustrated as light sources 84; however, it is contemplated that the light sources 84 may include tens, hundreds, and/or thousands of light sources 84.

In some examples, LEDs may be used as the individual light sources 84. The LEDs may have a diameter ranging from 10 to 50 microns and a height ranging from 5 to 20 microns. In some examples, the LEDs have a maximum width or length, whichever is longer, ranging from about 300 to 320 microns. In some examples, the individual light sources 84 (e.g., LEDs) have a diameter ranging from about 20 to 30 microns and a height ranging from about 5 to 50 microns. In some examples, the LEDs have dimensions ranging from 230 to 300 microns on one side, 180 to 200 microns on a second side, and 50 to 80 microns in height. Therefore, examples provided herein that include measurements referencing a thickness with respect to a light source 84 may be within 80 microns of the distance stated since the thickness of the light sources 84 is determined by the thickness of the substrate 104 (where thickness of the light sources 84 is a measure of the height of the profile of the light sources 84 or, equivalently, a measure of the distance from the surface of the outermost layer of the substrate 104 to the side of the light sources 84 disposed away from the outermost layer of the substrate 104). It will be appreciated, however, that any measurements provided herein are non-limiting examples. Any light sources 84 provided within the light-producing assembly 66 may be configured in any desired manner and within any distance of any other light sources 84 without departing from the teachings provided herein.

Furthermore, because the maximum width of unpackaged LEDs, which may be utilized as the light sources 84 of the currently described light-producing assembly 66, is less than that of standard packaged LEDs, space between the centers of each LED may be reduced, which therefore increases the uniformity of the perceived light. In some examples, the space between the centers of each unpackaged LED after being deposited is 0.05 millimeters. Since LEDs produce a “point” of light and because it is desirable in many applications to have uniform light (i.e., not being able to distinguish each point of light), as a rule of thumb, the diffusing offset distance (i.e., the minimum distance at which the light emitted from an LED array is perceived as uniform) may be approximately equal to the distance between the centers of adjacent LEDs. Therefore, for an LED light source 84, the diffusing offset distance may have a diffusing offset distance of approximately 0.05 millimeters.

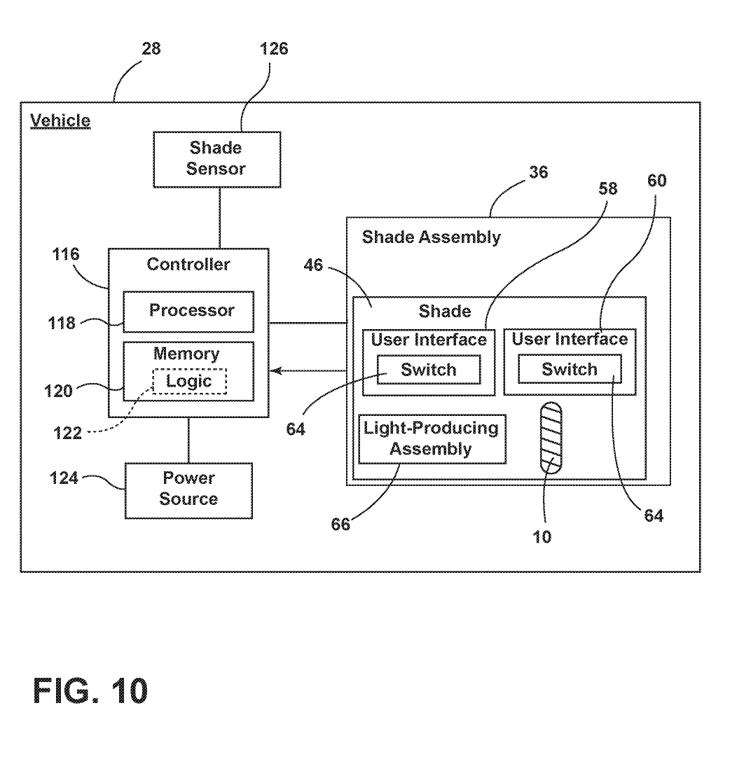

It will be understood that the light-producing assembly 66 may incorporate a single continuous light source 84 and/or a plurality of individual light sources 84. In examples where there is a plurality of light sources 84, some or all of the light sources 84 may be independently electrically connected (e.g., through a conductive ink 100). In independently electrically connected examples of the light sources 84, each of the light sources 84 may be independently addressable, which may allow a controller 116 (FIG. 10) to create static and dynamic patterns of light by independently illuminating certain light sources 84 and not others. In some instances, a machine may function to transfer unpackaged light sources 84 from a substrate such as a “wafer tape” to a product substrate, such as a circuit substrate. The direct transfer of unpackaged light sources 84 may reduce the thickness of an end product compared to a similar product produced by conventional means, as well as the amount of time and/or cost to manufacture the product substrate. Additional information on the formation of the plurality of light sources 84 and/or variously configured light-producing assemblies is disclosed in U.S. Patent Publication No. 2015/0136573 to Peterson et al. and U.S. Patent Publication No. 2016/0276205 to Huska et al., both of which are incorporated herein by reference.

In some examples, such as that illustrated in FIG. 8, the light-producing assembly 66 may have one or more first regions 106 that correspond to the one or more user interfaces 58, 60 that have light sources 84 oriented in an inboard direction and an outboard direction. The first regions 106 may provide backlight of the indicia layer 80, excite the luminescent structures 10 within the indicia layer 80, excite the emblem 74 on an inboard side of the shade 46, and/or provide lighting within the vehicle compartment. The outboard-oriented light sources 84 may excite the outboard luminescent structure 10 and/or otherwise emit light towards the window 34 of the vehicle 28. A second region 108 of the light-producing assembly 66 may have light sources 84 oriented in an outboard direction.

With further reference to FIG. 8, the one or more user interfaces 58, 60, and layers thereof may be disposed along discrete portions 110 of the shade 46. For example, each user interface 58, 60 may include the switch 64, the indicia layer 80, and the protective layer 82 along a top portion and a bottom portion of the shade 46. It will be appreciated, however, that each user interface 58, 60 may cover any portion, or all, of the shade 46 without departing from the teachings provided herein.

Referring to FIG. 9, as provided herein, the shade 46 may be formed from interwoven strands 76. In some examples, the strands 76 may be woven in a transverse manner in which a first set 112 of strands 76 are oriented in a first direction and a second set 114 of strands 76 is oriented in a second, transverse direction. However, it will be appreciated that the strands 76 may be disposed in any orientation in examples in which strands 76 of material are utilized for forming the shade 46.

As illustrated in FIG. 9, the outboard luminescent structure 10 may be disposed along an outer surface of the strands 76. Accordingly, the outboard luminescent structure 10 may be in a position to accept excitation light 24 through the window 34 of the vehicle 28. In response to receiving the excitation light 24, the luminescing of the outboard luminescent structure 10 may be exhibited from outside of the vehicle 28.

The emblem 74 may also be on an outboard side of the shade 46. The emblem 74 may also incorporate a luminescent structure 10 therein. As illustrated, the emblem 74 may cover the voids 78 between the strands 76. Accordingly, the emblem 74 may luminesce in response to receiving excitation light 24 through the window 34 of the vehicle 28 and/or from excitation light 24 emitted from the light-producing assembly 66 and through the voids 78 in the shade 46.

Referring now to FIG. 10, the vehicle 28 is further illustrated having a controller 116 receiving various inputs from the one or more switches 64 and controlling the light-producing assembly 66, the shade position, and/or activation/deactivation of a vehicle feature. The controller 116 may include a processor 118 and memory 120 as illustrated, according to various examples. It should be appreciated that the controller 116 may include control circuitry such as analog and/or digital control circuitry. Stored in memory 120 and executed by the processor 118 is logic 122 for processing the various inputs.

The controller 116 may provide electrical power to the shade 46 via the power source 124 located onboard the vehicle 28. In addition, the controller 116 may be configured to control the light output of the light-producing assembly 66 and/or switch activation/deactivation based on feedback received from a shade sensor 126. The shade sensor 126 may be a motion sensor (e.g., to detect deployment of the shade 46), a light sensor, and/or any other type of practicable sensor.

As provided herein, the one or more user interfaces 58, 60 may be activated based on the position of the shade 46, which may be determined by the shade sensor 126. For example, one or more of the user interfaces 58, 60 may be activated when the shade 46 is in the deployed position and deactivated when the shade 46 is in the stowed position or vice versa. One or more user interfaces 58, 60 may additionally, and/or alternatively, be activated in both the stowed and deployed positions. Moreover, the vehicle features that are controlled by the switches 64 disposed on the one or more user interfaces 58, 60 may dynamically change based on a vehicle condition (or feature) and/or the position of the shade 46.

With further reference to FIG. 10, the shade assembly 36 includes the shade 46, one or more user interfaces 58, 60, the light-producing assembly 66, and/or one or more luminescent structures 10. The shade 46 may be disposed in a plurality of positions that provide access to the one or more user interfaces 58, 60. Each user interface 58, 60 includes one or more switches 64 thereon for selective switching a vehicle feature between states. The selective switching is communicated to the controller 116 for controlling the desired vehicle feature. The light-producing assembly 66 may be utilized for exciting the one or more luminescent structures 10, providing backlights for each user interface 58, 60, illuminating indicia 68 within each user interface 58, 60, providing privacy illumination through a window 34 of the vehicle 28, providing ambient lighting, providing task lighting, and/or for any other desired purpose.

Referring still to FIG. 10, the luminescent structure 10 may be optically coupled with the light-producing assembly 66 and/or capable of accepting excitation light from the environment surrounding the vehicle 28. In operation, the luminescent structure 10 may include a plurality of luminescent materials 18 therein that luminesce in response to receiving light of a specific wavelength spectrum. According to various examples, the luminescent structure 10 discussed herein is substantially Lambertian; that is, the apparent brightness of the luminescent structure 10 is substantially constant regardless of an observer's angle of view. As described herein, the color of the converted light 26 may be dependent on the particular luminescent materials 18 utilized in the luminescent structure 10. Additionally, a conversion capacity of the luminescent structure 10 may be dependent on a concentration of the luminescent material 18 utilized in the luminescent structure 10. By adjusting the range of intensities that may excite the luminescent structure 10, the concentration, types, and proportions of the luminescent materials 18 in the luminescent structure 10 discussed herein may be operable to generate a range of color hues of the excitation light 24 by blending the first wavelength with the second wavelength.

Use of the present disclosure may offer a variety of advantages. For example, use of the illuminated shade assembly may increase the privacy and safety of the vehicle by emitting converted light out of the window of the vehicle to inhibit visibility into the vehicle. Additionally, the shade assembly may provide additional space to provide switches for selectively activating features of the vehicle. Moreover, the switches may be dynamically altered to control a wide array of features within an occupant accessible location. The shade may incorporate flexible conductive ink so that the user interfaces may be stowed in any linear and/or non-linear orientation within the housing. The light-producing assembly may excite indicia that are defined by a luminescent structure to display the specific vehicle feature that is controlled by each switch. The shade assembly may include any or all of the features provided herein and still is manufactured at low costs when compared to standard vehicle shade assemblies and lighting assemblies.

According to various examples, a shade assembly positioned proximate a window is disclosed herein. The shade assembly includes a housing and a shade configured to deploy from the housing. A user interface includes a switch for selectively activating a feature of a vehicle. The shade assembly may be configured as a vehicle shade assembly. Examples of the shade assembly can include any one or a combination of the following features:
an engaging member positioned on the shade and configured to couple with a retaining member disposed within the vehicle to maintain the shade in a deployed position;
a motor operably connected to the shade to move the shade between a stowed position and a deployed position;
a light-producing assembly operably coupled to the shade;
indicia disposed on the switch and configured to define the feature of the vehicle that is selectively controlled by the switch;
a luminescent structure disposed on the shade and configured to luminesce in response to receiving an excitation light;
the luminescent structure defines indicia that correlates to the vehicle feature that is controlled by the switch;
the luminescent structure is disposed on an outboard side of the shade and configured to emit light through a window disposed proximately to the shade;
the switch is configured as a proximity sensor;
the proximity sensor is a capacitive sensor that is formed with ink that is conductive and stretchable, the ink configured to move between the deployed and stowed positions with the shade without breaking;
the light-producing assembly includes a first region having light sources oriented in first and second opposing directions and a second region having light sources oriented in the first direction; and/or
the switch is selectively activated based on a position of the shade assembly.

Moreover, a method of controlling a vehicle feature is provided herein. The method includes positioning a housing proximate a vehicle window. A shade is disposed within the housing, the shade configured to deploy from the housing. A user interface is utilized that includes a switch for selectively activating said vehicle feature.

According to some examples, a shade assembly is positioned proximate a window. The shade assembly includes a housing and a shade configured to deploy from the housing. A user interface is disposed on the shade and includes a switch for selectively activating a vehicle feature. The switch is formed with ink that is conductive and stretchable. Examples of the shade assembly can include any one or a combination of the following features:
the ink is configured to move between the deployed and stowed positions with the shade without breaking; and/or
the switch is selectively activated based on a position of the shade assembly.

According to other examples, a shade assembly is disclosed herein. The shade assembly includes a housing and a shade configured to deploy from the housing. A switch is disposed on the shade. Examples of the shade assembly can include any one or a combination of the following features:
the switch is formed with ink that is conductive and stretchable and configured to move between a substantially linear and a non-linear orientation;
a light-producing assembly operably coupled to the shade;
the shade defines inboard and outboard surfaces and a luminescent structure is positioned on the outboard surface of the shade; and/or
the luminescent structure is configured to emit light through a window of a vehicle when the shade is in a deployed position.

It will be understood by one having ordinary skill in the art that construction of the described invention and other components is not limited to any specific material. Other exemplary examples of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

Furthermore, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable and/or physically interacting components and/or wirelessly interactable and/or wirelessly interacting components and/or logically interacting and/or logically interactable components. Furthermore, it will be understood that a component preceding the term “of the” may be disposed at any practicable location (e.g., on, within, and/or externally disposed from the vehicle) such that the component may function in any manner described herein.

It is also important to note that the construction and arrangement of the elements of the invention as shown in the exemplary examples is illustrative only. Although only a few examples of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For examples, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary examples without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A shade assembly positioned proximate a window, the shade assembly comprising:
a housing;
a shade configured to deploy from the housing; and
a user interface including a switch for selectively activating a feature of a vehicle.

2. The shade assembly of claim 1, further comprising:
an engaging member positioned on the shade and configured to couple with a retaining member disposed within the vehicle to maintain the shade in a deployed position.

3. The shade assembly of claim 1, further comprising:
a motor operably connected to the shade to move the shade between a stowed position and a deployed position.

4. The shade assembly of claim 1, further comprising:
a light-producing assembly operably coupled to the shade.

5. The shade assembly of claim 1, further comprising:
indicia disposed on the switch and configured to define the feature of the vehicle that is selectively controlled by the switch.

6. The shade assembly of claim 1, further comprising:
a luminescent structure disposed on the shade and configured to luminesce in response to receiving an excitation light.

7. The shade assembly of claim 6, wherein the luminescent structure defines indicia that correlates to the vehicle feature that is controlled by the switch.

8. The shade assembly of claim 6, wherein the luminescent structure is disposed on an outboard side of the shade and configured to emit light through a window disposed proximately to the shade.

9. The shade assembly of claim 1, wherein the switch is configured as a proximity sensor.

10. The shade assembly of claim 9, wherein the proximity sensor is a capacitive sensor that is formed with ink that is conductive and stretchable, the ink configured to move between the deployed and stowed positions with the shade without breaking.

11. The shade assembly of claim 4, wherein the light-producing assembly includes a first region having light sources oriented in first and second opposing directions and a second region having light sources oriented in the first direction.

12. The shade assembly of claim 1, wherein the switch is selectively activated based on a position of the shade assembly.

13. A shade assembly positioned proximate a window, the shade assembly comprising:
a housing;
a shade configured to deploy from the housing; and
a user interface disposed on the shade and including a switch for selectively activating a vehicle feature, wherein the switch is formed with ink that is conductive and stretchable.

14. The shade assembly of claim 13, wherein the ink is configured to move between the deployed and stowed positions with the shade without breaking.

15. The shade assembly of claim 13, wherein the switch is selectively activated based on a position of the shade assembly.

16. A shade assembly, comprising:
a housing;
a shade configured to deploy from the housing; and
a switch disposed on the shade.

17. The shade assembly of claim 16, wherein the switch is formed with ink that is conductive and stretchable and configured to move between a substantially linear and a non-linear orientation.

18. The shade assembly of claim 16, further comprising:
a light-producing assembly operably coupled to the shade.

19. The shade assembly of claim 16, wherein the shade defines inboard and outboard surfaces and a luminescent structure is positioned on the outboard surface of the shade.

20. The shade assembly of claim 19, wherein the luminescent structure is configured to emit light through a window of a vehicle when the shade is in a deployed position.
